(19) United States
(12) Patent Application Publication
(10) Pub. No.: US 2023/0020069 A1
(43) Pub. Date: Jan. 19, 2023

(54) A CAMERA SYSTEM FOR A MOBILE DEVICE, A METHOD FOR LOCALIZING A CAMERA AND A METHOD FOR LOCALIZING MULTIPLE CAMERAS

(71) Applicant: Sony Semiconductor Solutions Corporation, Kanagawa (JP)

(72) Inventors: Roderick KOEHLE, Stuttgart (DE); Francesco MICHIELIN, Stuttgart (DE)

(73) Assignee: Sony Semiconductor Solutions Corporation, Kanagawa (JP)

(21) Appl. No.: 17/784,109

(22) PCT Filed: Nov. 17, 2020
(86) PCT No.: PCT/EP2020/082448

§ 371 Date: Jun. 10, 2022

(30) Foreign Application Priority Data
Dec. 19, 2019 (EP) 19218285.5

(51) Int. Cl. G06T 7/73; H04N 13/239

(52) U.S. Cl. CPC G06T 7/74; H04N 13/239; G01P 15/18

(57) ABSTRACT

The present disclosure relates to a camera system for a mobile device. The camera system comprises at least one camera which is freely mounted to the mobile device. Further, the camera system comprises at least one motion measurement unit configured to provide motion data of the camera and a data processing circuitry configured to determine a pose of the camera from the motion data.

### FIELD

Embodiments of the present disclosure relate to a camera system for a mobile device, a method for localizing a camera and a method for localizing multiple cameras of a camera system.

### BACKGROUND

In the automotive sector, vision based driver assistance systems (ADAS) are emerging for various applications such as parking assistance, sideline warnings and collision detection. For parking assistance surround view, for example, four cameras can be used to provide a 360 degree view of an environment of a vehicle. For collision and sideline detection stereo cameras can be used which are configured to estimate distances and speed of objects in the environment.

For driving autonomy, the vehicle can be enabled to estimate its own path of driving and recognize its three-dimensional (3D) environment while driving. For this, applications may need to provide an appropriate spatial accuracy. Therefore, for example, cameras need to be calibrated and rigidly mounted such that the 3D environment can be estimated from a relative position and orientation of the cameras. In case of stereo view, a pre-calibration can be done in a factory or workshop.

A distance between the cameras is limited to a maximum distance as the rigidly mounted cameras may experience calibration issues due to torsion, vibrations or relative motion of the cameras. Thus, mounting the cameras rigidly to a chassis of the vehicle can be inappropriate for autonomous driving applications as motor vibrations and chassis torsion may affect the distance and orientation of cameras.

Hence, there may be a demand for an improved concept to determine a pose of a camera.

### SUMMARY

This demand can be satisfied by the appended independent and dependent claims.

According to a first aspect, the present disclosure relates to a camera system for a mobile device. The camera system comprises at least one camera which is freely mounted to the mobile device. Further, the camera system comprises at least one motion measurement unit configured to provide motion data of the camera and a data processing circuitry configured to determine a pose of the camera from the motion data.

The mobile device is, for example, a vehicle (e.g. a car, a truck, a bus, a boat, a plane, a motorcycle, a bicycle or an unmanned aerial vehicle) or a handheld device.

The camera can be freely mounted to the mobile device using a damping plate or a (camera) stabilizer to at least partly reduce, compensate or absorb torsion and/or vibrations which may emanate from the mobile device.

The stabilizer, for example, comprises a pivoted support (e.g. a gimbal) which allows a rotation of the camera about at least one axis to mount the camera to the mobile device in a floating position.

The damping plate can be at least partially made of an elastic material to mount the camera freely (elastically) to the mobile device.

Thus, the camera may be considered as loosely coupled or freely or floating mounted to the mobile device.

The camera can be a video/movie camera.

The motion data, for example, is indicative of an acceleration and/or an angular velocity of the camera. The angular velocity and/or the acceleration for example can be measured by a gyroscope comprised of the motion measurement unit.

Since the camera is freely mounted to the mobile device, the camera may change its pose. The pose can be understood as a relative position and/or orientation within an environment to the mobile device.

The camera, for example, can be subjected to the angular velocity while the mobile device is moving. The data processing unit can determine the pose of the camera, for example, from a relationship between an angular velocity and the pose of the camera.

This may enable a so-called auto-calibration of the camera system with regard to the pose of the camera, making a pre-calibration or a re-calibration (e.g. at a factory or a workshop) of the camera system obsolete.

According to a second aspect, the present disclosure relates to a method for localizing a camera of a camera system for a mobile device. The method comprises providing motion data of the camera, which is freely mounted to the mobile device, using at least one motion measurement unit. The method further comprises determining a pose of the camera from the motion data.

The method, for example, can be executed using the aforementioned camera system.

According to a third aspect, the present disclosure relates to a camera system comprising a first camera and a first motion measurement unit configured to provide first motion data of the first camera. Further, the camera system comprises at least one second camera and a second motion measurement unit configured to provide second motion data of the second camera. Moreover, the camera system comprises a data processing circuitry configured to determine a relative pose of the first camera and the second camera towards each other from a correlation between the first motion data and the second motion data.

The first and the second camera can be a video/movie camera.

The first and the second motion data, for example, are indicative of an acceleration and/or an angular velocity of the first and the second camera, respectively. The first and the second motion measurement unit, for example, each comprise a gyroscope for measuring the angular velocity or the acceleration acting on the first and the second camera, respectively.

Due to a different pose of the first and the second camera, the first and the second motion data may be different from each other. Further, the first and the second motion data can correlate in such a way that, for example, a distinct difference between the first and the second motion data is indicative of a distinct relative pose to each other.

This may enable an auto-calibration of the camera system to adapt the camera system, for example, to a varying relative pose of the first and the second camera towards each other. The relative pose, for example, rapidly changes due to vibrations acting on the first and/or the second camera. Alternatively and/or additionally the relative pose may change due to linear thermal expansion with a variation of an ambient temperature.

The auto-calibration may ensure an appropriate spatial accuracy of the camera system which may be required for applications in connection with autonomous driving vehicles.

According to a fourth aspect, the present disclosure relates to a method for localizing multiple cameras of a camera system for a mobile device. The method comprises providing first motion data of a first camera of the camera system using a first motion measurement unit. The method further comprises providing second motion data of at least one second camera of the camera system using a second motion measurement unit. Moreover, the method comprises determining a relative pose of the first camera and the second camera towards each other through a comparison of the first motion data and the second motion data.

This method, for example, can be executed using the aforementioned camera system comprising the first and the second camera.

According to a fifth aspect, the present disclosure relates to a computer program comprising instructions which, when executed by at least one processor, causes the processor to perform one of the aforementioned methods.

According to a sixth aspect, the present disclosure relates to a mobile device which comprises one of the aforementioned camera systems.

The mobile device can be a vehicle or a handheld device. In particular, the mobile device can be an autonomously driving vehicle.

According to a seventh aspect, the present disclosure relates to a distributed camera system comprising a first camera configured to provide a first sequence of images of an environment a first motion measurement unit configured to provide first motion data of the first camera and a first data processing circuitry. The first data processing circuitry is configured to determine a position of target within the environment from a correlation between the first motion data and the first sequence of images register the position of the target in a digital map of the environment. Further, the first data processing circuitry is configured to provide the digital map of the environment.

The distributed camera system further comprises at least one second camera configured to provide a second sequence of images of an environment, a second motion measurement unit configured to provide second motion data of the second camera and a second data processing circuitry. The second data processing circuitry is configured to determine a relative pose of the first camera and the second camera towards each other from a correlation between the first motion data and the second motion data. The second data processing circuitry is further configured to receive the digital map of the environment and detect the target within at least one of the images of the second sequence of images based on and the digital map and the relative pose of the first camera and the second camera towards each other.

The distributed camera system can be understood as an apparatus with multiple camera system each comprising a camera, a motion measurement unit and a data processing circuitry.

In some embodiments, the first camera, the first motion measurement unit and the first data processing circuitry may be mounted to a first mobile device and the second camera, the second motion measurement unit and the second data processing circuitry may be mounted to a second mobile device.

In some applications it may be desired to track the target with multiple cameras. Thus, it can be useful to identify the target within the second sequence of images.

For this, the digital map can be shared within the first and the second data processing circuitry. The second data processing circuitry thus can estimate a position of the target within one or more images of the second sequence of images by reference to the digital map and the relative pose of the first and the second camera.

The skilled person having benefit from the present disclosure will appreciate that this may be desired for tracking purposes in some applications in which the first and the second camera have different and/or opposite fields of view.

### BRIEF DESCRIPTION OF THE FIGURES

Some examples of apparatuses and/or methods will be described in the following by way of example only, and with reference to the accompanying figures, in which

FIG. 1 shows a schematic example of a camera system for a mobile device;

FIG. 2 illustrates tracking a target using the camera system;

FIG. 3 illustrates a motion path of the mobile device and a 3-dimensional map for a characterization of an environment of the mobile device;

FIG. 4 illustrates a characterization of the environment using the 3-dimensional map;

FIG. 5 shows a schematic example of a camera system comprising a first and a second camera;

FIG. 6 shows a schematic example of the camera system comprising the first and the second camera mounted to a mobile device;

FIG. 7 shows a flow chart schematically illustrating a method for localizing a camera; and

FIG. 8 shows a flow chart schematically illustrating a method for localizing multiple cameras.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

For purposes of autonomous driving, one or more cameras can be utilized to characterize an environment of a vehicle. For this, camera systems can be pre-calibrated to a pose of the cameras. Since those can be mounted to the vehicle, the cameras may be subjected to torsion and/or vibrations which may lead to calibration issues and in some cases to such a characterization of the environment which is inappropriate for autonomous driving purposes.

Hence, there may be a demand for an improved concept for determining a pose of a camera.

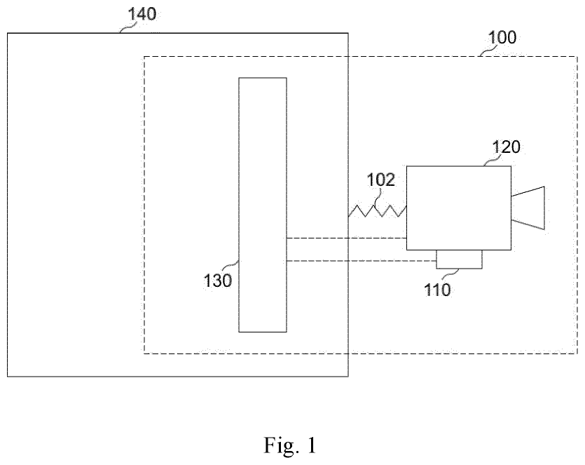

FIG. 1 shows a schematic example of a camera system 100. The camera system 100 comprises a camera 120 and a motion measurement unit 110 configured to provide motion data of the camera 120. Further, the camera system 100 comprises a data processing circuitry 130 configured to determine a pose of the camera 120 from the motion data.

The camera 100 is freely mounted to a mobile device 140. As can be seen in FIG. 1, the camera 100 can be freely mounted to the mobile device 140 by a stabilizing mounting 102 for a floating mounting.

The stabilizing mounting 102 can at least partly absorb vibrations coming from the mobile device 140. For example, the stabilizing mounting 102 comprises a camera stabilizer (e.g. a gimbal) and/or an elastic mounting, such as a damping plate.

The motion measurement unit 110 can comprise an inertial measurement unit (IMU) which is rigidly mounted to the camera 120. The skilled person having benefit from the present disclosure will appreciate that the IMU can provide a portion of the motion data using a combination of one or more accelerometers, gyroscopes, and/or magnetometers. The motion data from the IMU, thus, may be indicative of an acceleration and/or an angular velocity of the camera 120.

Alternatively or additionally, the motion measurement unit 110 can comprise a global positioning system (GPS) sensor which is installed at the mobile device 140 and configured to provide at least a portion of the motion data. The GPS sensor can provide a geographical position, a velocity of the mobile device 140 or a course of the geographical position which may contribute to the motion data.

The motion measurement unit 110 may comprise both the IMU and the GPS sensor for a higher operational reliability than each of the IMU and the GPS sensor.

The motion measurement unit 110 is coupled to the data processing circuitry 130 to communicate the motion data.

Due to a relationship between the pose of the camera 120 and the motion data, the data processing circuitry 130 can determine the pose of the camera 120.

For example, the camera 120 can be displaced from a predefined position by an angular velocity. A displacement of the camera 120 from the predefined position may depend on an orientation and an absolute value of the angular velocity. The data processing circuitry 130, for example, is calibrated to determine the displacement and the pose of the camera 120 from the angular velocity included in the motion data.

This may enable an auto-calibration of the camera system 100 based on the pose of the camera 120 on the mobile device 130 to recover a spatial accuracy of a characterization of the environment using the camera system 100.

In case of automotive applications, the mobile device 140 can be a vehicle. In particular, the mobile device 140 can be an autonomously driving vehicle functioning based on a characterization of the environment using the camera system 100.

For example, the autonomously driving vehicle may move on public roads, take evasive maneuvers or output a warning based on the characterization of the environment.

To improve an accuracy of the auto-calibration, the data processing circuitry 130 can further involve visual data for determining the pose of the camera 120. For this, the camera 120 can be a video/movie camera which records a sequence of images of the environment.

To characterize its pose within the environment, the camera 120 can provide a sequence of images of the environment to the processing circuitry 130. This, for example enables the data processing circuitry 130 to determine the pose from a correlation between the sequence of images and the motion data, as stated in more detail below.

For a communication of the sequence of images, the camera 120 is coupled with the data processing circuitry 130.

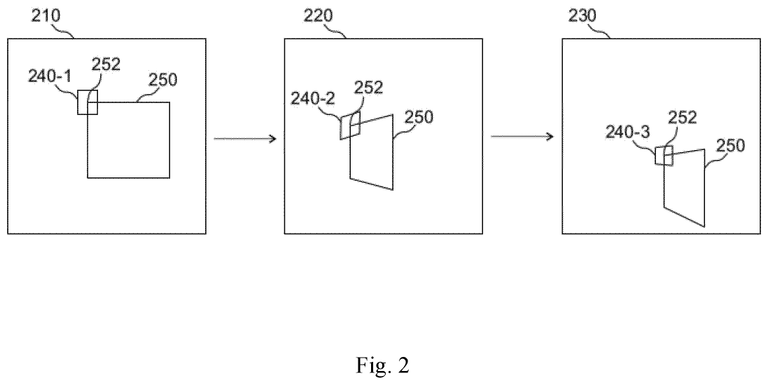

As can be seen in FIG. 2, the camera 120, for example, provides a sequence of subsequent images of the environment. To simplify matters, a following description of a localization of the camera 120 refers to a first image 210, a second image 220 and a third image 230 of the sequence of images. In general, the sequence of images can comprise more images and the concept described below can also be applied to more images.

Each of the images 210, 220 and 230 includes an object 250 of the environment. Without limitation of generality and to simplify matters, the localization of the camera 120 is described by reference to the object 250, whereas in further use cases the localization of the camera 120 may involve multiple objects.

A basic idea of the localization of the camera 120 is that the data processing circuitry 130 determines a change of perspective of the camera 120 by comparing the first image 210 of the sequence of images with the second image 220.

The (absolute) pose of the camera 120 towards the object 250 can be derived from a correlation between the motion data and the change of perspective on the object 250, as stated in more detail below.

The data processing circuitry 130, for example, determines a first patch 240-1 within the first image 210. As can be seen in FIG. 2, the first patch 240-1 may correspond to a box including a distinct target 252, such as a portion of a contour (e.g. a corner or an edge) of the object 250.

The first patch 240-1 may cover “unique” so-called “photo-differences” of the first image 210. If the images 210, 220 and 230 are monochrome, the photo-differences, for example, are indicative of a characteristic distribution of greyscale values (greyscale distribution) of pixels included in the first patch 240-1. Alternatively, the photo-differences can be understood of a distribution of color or contrast.

Subsequently, the data processing circuitry 130 can determine a second patch 240-2 indicative of the target 252 within the second image 220 by comparing the first patch 240-1 with the second image 220.

The first and the second patch 240-1 and 240-2, for example, are specified by their contour and by a position of their center within the first and the second image 210 and 220.

The data processing circuitry 130 may arrange the second patch 240-2 within the second image 220 such that the second patch 240-2 includes the photo-differences of the first patch 240-1 (within predetermined tolerances). This may ensure that the second patch 240-2 relates to the same target 252.

Due to a change of perspective, the second patch 240-2 may be shifted regarding to the first patch 240-1. A shift between the first and the second patch 240-1 and 240-2 may imply so-called “affine correspondences” defining a transition between the subsequent patches 240-1 and 240-2. Those may consider a rotation, a displacement, a warp and/or a shear of the patches 240-1 and 240-2.

As can be seen in FIG. 2, the second patch 240-2, for example, corresponds to a trapezoid/parallelogram.

The data processing circuitry 130 can deduce the change of perspective of the camera 120 from the affine correspondences between the first and the second patch 240-1 and 240-2. For example, the data processing circuitry 130 deduces the change of perspective, which, for example, is indicative of an angle, based on principles of homography.

The skilled person having benefit from the present disclosure will appreciate that the change of perspective may enable estimating a visually measurable pose of the camera 120 towards the target 252 in accordance with principles of visual odometry.

The visually measureable pose, for example, refers to a relative position or relative orientation of the camera 120 towards the target 252 with respect to other targets.

To obtain the (absolute) pose (e.g. indicative of coordinates or a measure of length) of the camera 120 towards the target 252, the data processing circuitry 130 can provide a scale to deduce an absolute value for the pose of the camera 120 from the visually measureable pose of the camera 120.

For this, the data processing circuitry 130 may associate the visual data with the motion data.

In some embodiments of the camera system 100, the data processing circuitry 130 determines the pose of the camera 120 using a Kalman filter, wherein a control vector of the Kalman filter is specified by the motion data and a measured state is defined by the relative pose derived from to the visual data.

A relation between the motion data and the visual data may provide an observation model of the Kalman filter. With the observation model, the relative pose of the camera 120 can be scaled to obtain the pose of the camera 120 as an absolute value, for example, indicative of coordinates and/or an angle.

Thus, the visual data and the motion data both may have an influence in determining the pose of the camera 120. Their influence may depend on a weighting factor indicative of an accuracy of the motion data and of the visual data, respectively to adapt the camera system 100 to different circumstances (e.g. a dark environment).

The above described concept for determining the pose of the camera 120 may also be referred to as “affine flow tracking”.

Affine flow tracking may need the motion data and the sequence of images to be time-synchronized.

In some embodiments, the data processing circuitry can be configured to determine a third patch 240-3 indicative of the target 252 within a third image 230 following the second image 220 by comparing the first patch 240-1 with the third image 230. The data processing circuitry 130 can determine the third patch 240-3 analogously to the second patch 240-2 by reference to the first patch 240-1.

This may prevent the third patch 240-3 and subsequent patches from “drifting” away from the target 252 due to an error propagation and may provide subpixel accurate matching of subsequent patches with the target 252 for both temporal tracking and spatial mapping of subsequent patches by reference to subsequent images of the sequence of images.

Subsequently, the data processing circuitry 130 can determine the change of perspective from a shift/affine correspondences between the first and the third patch 240-1 and 240-3 to determine the pose of the camera 120.

Since the third patch 240-3 can be considered as being mapped onto the first patch 240-1 for determining the pose of the camera 120, this concept can be referred to as “affine flow mapping”.

Additionally, the data processing circuitry 130 can determine a position of the target from the correlation between the change of perspective and the motion data.

For this, the pose of the camera 120 may be considered as an origin of a coordinate system. Consequently, the data processing circuitry 130 may determine the position of the target 252 within the coordinate system from the pose of the camera 120 towards the target 252.

The position of the target 252 within the coordinate system, for example, is indicative of 3-dimensional coordinates.

In some embodiments of the camera system 100, the data processing circuitry 130 is further configured to determine a velocity of the target 252 by tracking the position of the target 252.

For this, the data processing circuitry 130, for example, continuously determines the position of the target 252, as stated above, to derive its motion from temporal changes of the position. Implicitly, the data processing circuitry 130 can determine the velocity from the motion.

Further, the camera system 100 can determine whether the target 252 is static or moving within the environment by tracking the position of the target 252.

For example, the camera system 100 can analogously track positions of other targets surrounding the target 252 to ascertain whether the target 252 moves relative to the other targets.

If the position of the other targets does not change over time, those targets can be identified as static targets which do not move within the environment.

If the target 252 moves relative to one or more of the static targets, it can be identified as a moving target.

Alternatively, the data processing circuitry 130 can compare velocities of several targets to distinguish between static and moving targets.

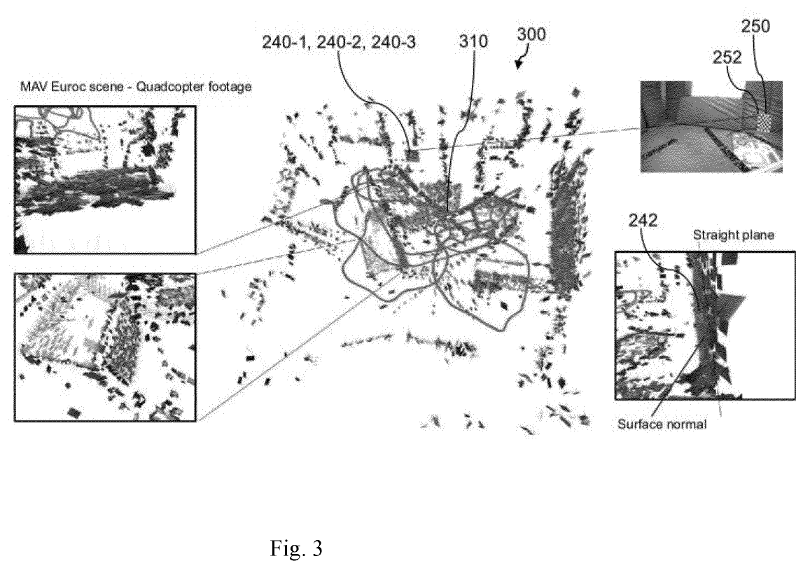

As illustrated by FIG. 3, the data processing circuitry 130 may register the position of the target 252 in a (3-dimensional) digital map 300 of the environment, for example, by mapping one or multiple of the patches 240-1, 240-2 and 240-3 onto the position of the target 252 within the digital map 300.

Thus, multiple targets can be continuously registered in the digital map 300 during a motion of the camera 120 along a motion path 310.

The patches 240-1, 240-2, 240-3 are further characterized by a surface normal 242. Consequently, the data processing circuitry 130 can characterize surfaces of the environment in terms of their orientation.

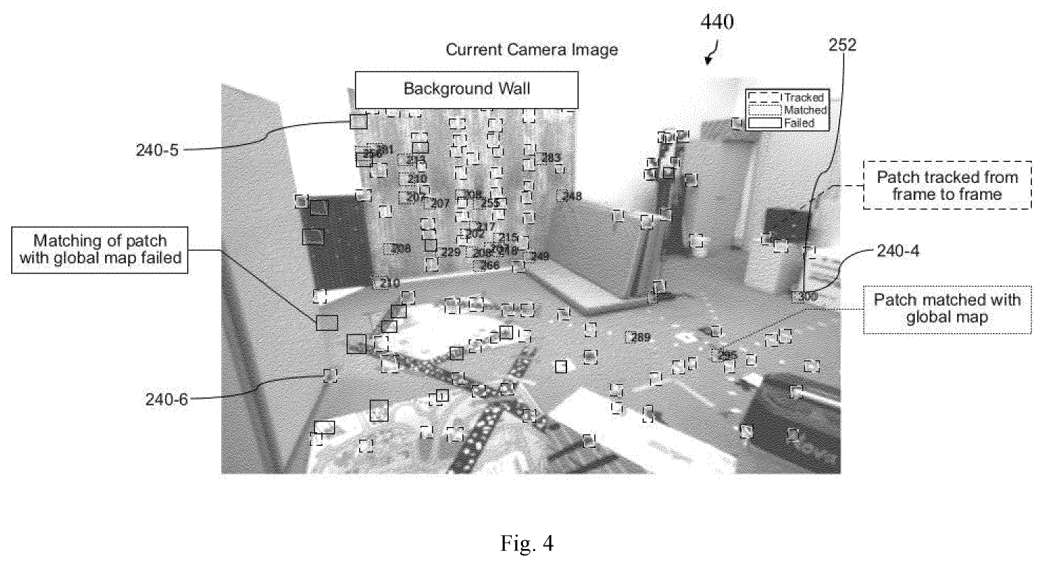

As can be seen in FIG. 4, the digital map 300 enables the data processing circuitry 130 to determine a fourth patch 240-4 indicative of the target 252 within a fourth image 440 based on the pose of the camera 120 and the digital map 300.

In some embodiments of the camera system 100, the data processing circuitry 130 is configured to compare the position of the target 252 with the pose of the camera 120 to predict a position of the target 252 within the fourth image 440. Consequently, the data processing circuitry 130 may align the fourth patch 240-4 with the predicted position.

Additionally, the data processing circuitry 130 can be configured to determine whether the fourth patch 240-4 matches with one or more of the preceding/registered patches 240-1, 240-2 and 240-3 and optionally determine a deviation from the preceding patches 240-1, 240-2 and 240-3.

The deviation, for example, enables a (auto-) re-calibration of the pose of the camera 120.

In some cases a patch 240-5 cannot be mapped to target and/or proper patches registered in the digital map 300. Consequently, such targets or patches can be ignored in connection with the characterization of the environment and/or discarded from the digital map 300.

During a motion of the camera 120, the data processing circuitry 130 can also continuously detect “new” targets to associate “new patches” 240-6 with those.

The digital map 300 can further be shared with a supplementary camera supporting visual odometry for a characterization of the environment. In general, a field of view from the supplementary camera can differ from a field of view of the camera 120.

Sharing the digital map 300 can enable the supplementary camera to associate another patch with the target 252 by reference to the digital map 300 and a pose of the supplementary camera to provide an auto-calibration between the camera 120 and the supplementary camera.

This, for example, can be desired in connection with a driver assistance system using multiple differently oriented cameras.

As mentioned above, in some applications can be a demand for using multiple cameras.

In camera systems with multiple cameras, the cameras can experience relative motion to each other or vibrations, for example, in connection with automotive applications. Consequently, a relative position of the multiple cameras can be subjected to variations which may cause calibration issues. Those calibration issues may lead to an insufficient characterization of the environment.

Hence, there is a demand for an improved concept for a characterization of an environment using multiple cameras to overcome such calibration issues emerging from variations of a relative position of the cameras towards each other.

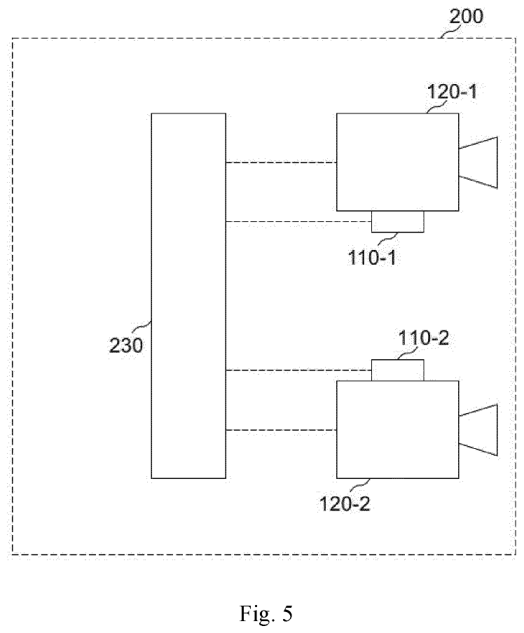

FIG. 5 illustrates a camera system 200 which comprises a first camera 120-1 and a first motion measurement unit 110-1 which is configured to provide first motion data of the first camera 120-1. Further, the camera system 200 comprises at least one second camera 120-2 and a second motion measurement unit 120-2 configured to provide second motion data of the second camera 120-2. Additionally, the camera system 200 comprises a data processing circuitry 230 configured to determine a relative pose of the first camera 120-1 and the second camera 120-2 towards each other from a correlation between the first motion data and the second motion data.

For this, the first and the second motion measurement unit 110-1 and 110-2 are coupled to the data processing circuitry 230.

In some embodiments, the data processing circuitry 230 may comprise a first and a second processing circuitry (not shown) each mounted to the first and the second camera 120-1 and 120-2. This may be desired if the first and the second camera 120-1 and 120-2 are mounted to separate mobile devices.

In some embodiments, the data processing circuitry 230 may correspond to the data processing circuitry 130 described in connection with the camera system 100.

The relative position of the first and the second camera 120-1 and 120-2 may relate to a relative motion of the cameras 120-1 and 120-2. Ipso facto, the relative position can be derived from the first and the second motion data indicative of the relative motion.

The first and/or the second motion data are, for example, indicative of an angular velocity and/or accelerations acting on the cameras 120-1 and 120-2.

The data processing circuitry 230, for example, determines the relative position of the cameras 120-1 and 120-2 from differences between the first and the second motion data.

In this way, the data processing circuitry 230 enables an auto-calibration of the camera system 200 with reference to the relative position of the cameras 120-1 and 120-2 to recover a spatial accuracy of the camera system 200.

In some further embodiments of the camera system 200, the first camera 120-1 is configured to provide a first sequence of images of an environment and the second camera 120-2 is configured to provide a second sequence of images of the environment. In connection with those embodiments the data processing circuitry 230 can be further configured to determine the relative pose of the first camera 120-1 and the second camera 120-2 towards each other from a correlation between the first motion data, the second motion data, the first sequence of images and the second sequence of images.

For this, the first and the second motion data and the first and the second sequence of images may be time-synchronized.

To communicate the first and the second sequence of images to the data processing circuitry 230, each of the cameras 120-1 and 120-2 may be coupled with the data processing circuitry 230.

The data processing circuitry 230 may apply concepts of visual odometry to the first and the second sequence of images as described in connection with the aforementioned embodiments of the camera system 100.

For example, the data processing circuitry 230 utilizes a Kalman filter to determine the relative pose of the cameras 120-1 and 120-2.

An observation model of the Kalman filter can be derived from the correlation of affine correspondences between images of the first and the second sequence of images and a difference between the first and the second motion data.

A control vector of the Kalman filter may be specified by the first and the second motion data, whereas a measured state of the relative pose of the cameras 120-1 and 120-2 may be indicative of the affine correspondences.

This may enable the Kalman filter to continuously determine the relative pose of the first and the second camera 120-1 and 120-2 by reference to the first and the second motion data and the first and the second sequence of images.

In this way, the camera system 200 may increase an accuracy of the relative position compared to aforementioned embodiments of the camera system 200 using (only) the motion data for determining the relative position of the cameras 120-1 and 120-2.

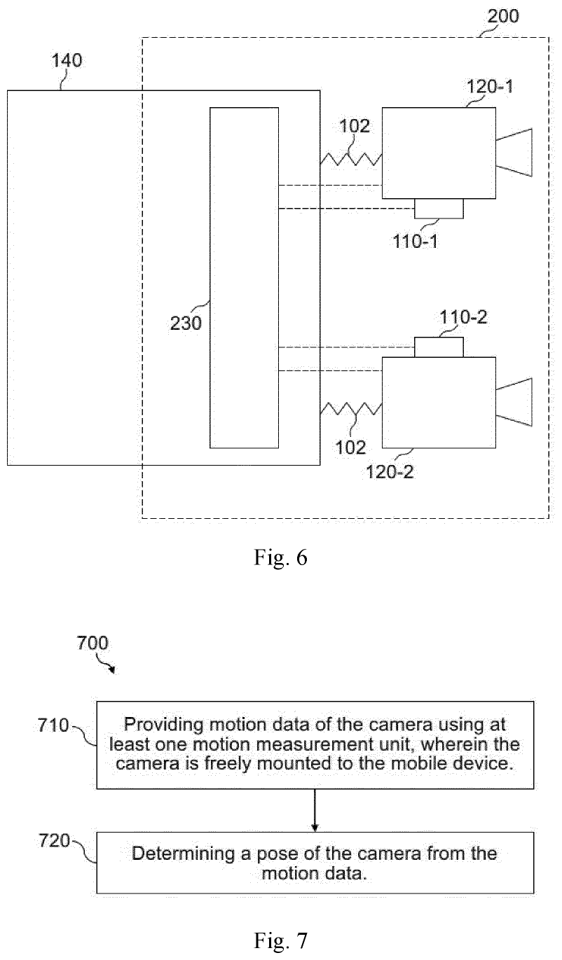

As can be seen in FIG. 6, the first and the second camera are freely mounted (mounted in floating position) to the mobile device 140. For this, each of the cameras 120-1 and 120-2 can be coupled to the mobile device 140 using the stabilizing mounting 102.

In this manner, perturbations (e.g. vibrations and/or torsion) coming from the mobile device may be attenuated to improve a spatial accuracy of the first camera 120-1 and/or the second camera 120-2.

In some embodiments, the first camera 120-1 is mounted to a first mobile device (not shown) and the second camera 120-2 is mounted to a second mobile device (not shown).

Each of the first and the second mobile device, for example, is an unmanned aerial vehicle (UAV). Since the UAVs may move relative to each other, the relative pose of the cameras 120-1 and 120-2 may change.

With an aforementioned concept for determining the relative pose of the first and the second camera 120-1 and 120-2, the camera system 200 may be enabled to (continuously) auto-calibrate the camera system 200 with regard to the relative pose.

In some embodiments of the camera system 200, the data processing circuitry 230 is further configured to determine a position of a target within the environment from a correlation between the first sequence of images and the first motion data. Further, the data processing circuitry 230 can be configured to register the position of the target in a digital map of the environment and detect the target within the second sequence of images using the digital map, the motion data and the relative pose of the first and the second camera 120-1 and 120-2.

This can be desired, for example, if the first and the second camera 120-1 and 120-2 are mounted to different mobile devices or have opposite fields of view like in case of some driving assistance systems.

The data processing circuitry 230, for example, determines the position of the target using the first sequence of images and the first motion data and may register the position of the target in a 3-dimensional map 300 as described in connection with the camera system 100.

By reference to the relative pose of the first and the second camera 120-1 and 120-2, the motion data and the digital map, the data processing circuitry 230 can determine if the target is within the field of view of the second camera 120-2. Further, this may enable the data processing circuitry 230 to predict a position of the target within images of the second sequence of images with a deviation from a position of the target derived from the second sequence of images.

The skilled person having benefit from the present disclosure may appreciate that this deviation may be used for an auto-calibration of the first and the second camera 120-1 and 120-2 such that the auto-calibration causes the deviation to decrease.

FIG. 7 schematically illustrates a method 700 for localizing a camera of a camera system for a mobile device. The method comprises providing 710 motion data of the camera using at least one motion measurement unit, wherein the camera is freely mounted to the mobile device. Further, the method comprises determining 720 a pose of the camera from the motion data.

The method 700 can be executed, for example, by the camera system 100. For this, at least a portion of the method 700 can be performed by the data processing circuitry 130 by executing an appropriate computer program.

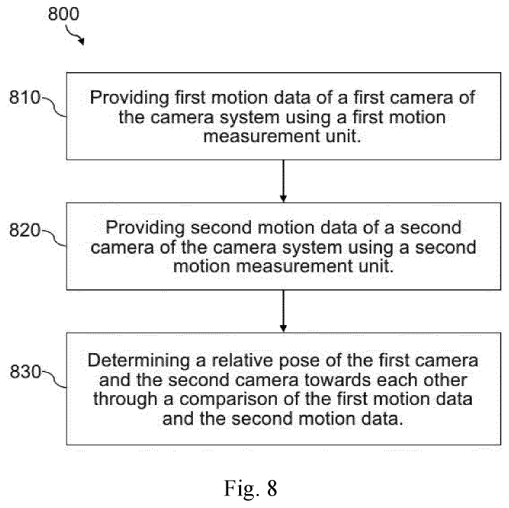

FIG. 8 schematically illustrates method 800 for localizing multiple cameras of a camera system for a mobile device. The method 800 comprises providing 810 first motion data of a first camera of the camera system using a first motion measurement unit. The method 800 further comprises providing 820 second motion data of at least one second camera of the camera system using a second motion measurement unit. Moreover, the method 800 provides for determining 830 a relative pose of the first camera and the second camera towards each other through a comparison of the first motion data and the second motion data.

The method 800 can be executed, for example, by the camera system 200. For this, at least a portion of the method 800 can be performed by the data processing circuitry 230 by executing an appropriate computer program.

The following examples pertain to further embodiments:

(1) A camera system for a mobile device, comprising:

at least one camera, wherein the camera is freely mounted to the mobile device;

at least one motion measurement unit configured to provide motion data of the camera; and

a data processing circuitry configured to determine a pose of the camera from the motion data.

(2) Camera system of (1),

wherein the camera is configured to provide a sequence of images of an environment; and

wherein the data processing circuitry is further configured to determine a pose of the camera within the environment from a correlation between the sequence of images and the motion data.

(3) Camera system of (2), wherein the data processing circuitry is further configured to

determine a change of perspective of the camera by comparing a first image of the sequence of images with a second image of the sequence of images following the first image; and

determine the pose of the camera within the environment from a correlation between the motion data and the change of perspective.

(4) The camera system of (3), wherein the data processing circuitry is further configured to determine a first patch within the first image, wherein the first patch is indicative of a target within the environment;

determine a second patch indicative of the target within the second image by comparing the first patch with the second image; and

determine the change of perspective from a shift between the first and the second patch.

(5) The camera system of (4), wherein the data processing circuitry is further configured to

determine a third patch indicative of the target within a third image following the second image by comparing the first patch with the third image; and

determine the change of perspective from a shift between the first and the third patch.

(6) The camera system of (4) or (5), wherein the data processing circuitry is further configured to determine a position of the target from the correlation between the change of perspective and the motion data.

(7) The camera system of (6), wherein the data processing circuitry is further configured to determine whether the target is static or moving within the environment by tracking the position of the target.

(8) The camera system of (6), wherein the data processing circuitry is further configured to determine a velocity of the target by tracking the position of the target.

(9) The camera system of (6), wherein the data processing circuitry is further configured to

register the position of the target in a digital map of the environment; and

determine a fourth patch indicative of the target within a fourth image based on the pose of the camera and the digital map.

(10) The camera system of any of (1) to (9), wherein the motion measurement unit comprises an inertial measurement unit, IMU, which is rigidly mounted to the camera and configured to provide at least a portion of the motion data.

(11) The camera system of any of (1) to (10), wherein the motion measurement unit comprises a global positioning system, GPS, sensor which is installed at the mobile device and configured to provide at least a portion of the motion data.

(12) The camera system of any of (1) to (11), wherein the camera is freely mounted to the mobile device by a camera stabilizer.

(13) The camera system of any of (1) to (12), wherein the camera is freely mounted to the mobile device by an elastic mounting.

(14) A camera system, comprising a first camera;

a first motion measurement unit configured to provide first motion data of the first camera;

at least one second camera;

a second motion measurement unit configured to provide second motion data of the second camera; and

a data processing circuitry configured to determine a relative pose of the first camera and the second camera towards each other from a correlation between the first motion data and the second motion data.

(15) The camera system of (14),

wherein the first camera is configured to provide a first sequence of images of an environment;

wherein the second camera is configured to provide a second sequence of images of the environment; and

wherein the data processing circuitry is further configured to determine the relative pose of the first camera and the second camera towards each other from a correlation between the first motion data, the second motion data, the first sequence of images and the second sequence of images.

(16) The camera system of (14) or (15), wherein at least one of the first and the second camera is freely mounted to a mobile device.

(17) The camera system of any one of (14) to (16), wherein the data processing circuitry is further configured to determine a position of a target within the environment from a correlation between the first sequence of images and the first motion data;

register the position of the target in a digital map of the environment; and

detect the target within the second sequence of images using the digital map, the motion data and the relative pose of the first and the second camera.

(18) The camera system of (14), wherein the first camera is mounted to a first mobile device and the second camera is mounted to a second mobile device.

(19) A method for localizing a camera of a camera system for a mobile device, comprising:

providing motion data of the camera using at least one motion measurement unit, wherein the camera is freely mounted to the mobile device; and

determining a pose of the camera from the motion data.

(20) A method for localizing multiple cameras of a camera system for a mobile device, comprising:

providing first motion data of a first camera of the camera system using a first motion measurement unit;

providing second motion data of at least one second camera of the camera system using a second motion measurement unit; and

determining a relative pose of the first camera and the second camera towards each other through a comparison of the first motion data and the second motion data.

(21) A distributed camera system, comprising:

a first camera configured to provide a first sequence of images of an environment;

a first motion measurement unit configured to provide first motion data of the first camera;

a first data processing circuitry configured to
determine a position of target within the environment from a correlation between the first motion data and the first sequence of images;
register the position of the target in a digital map of the environment; and
provide the digital map of the environment.

at least one second camera configured to provide a second sequence of images of an environment;

a second motion measurement unit configured to provide second motion data of the second camera; and

a second data processing circuitry configured to
determine a relative pose of the first camera and the second camera towards each other from a correlation between the first motion data and the second motion data;
receive the digital map of the environment; and
detect the target with at least one of the images of the second sequence of images based on and the digital map and the relative pose of the first camera and the second camera towards each other.

(22) A vehicle comprising the camera system of (1).

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A camera system for a mobile device, comprising:
at least one camera, wherein the camera is freely mounted to the mobile device;
at least one motion measurement unit configured to provide motion data of the camera; and
a data processing circuitry configured to determine a pose of the camera from the motion data.

2. Camera system of claim 1,
wherein the camera is configured to provide a sequence of images of an environment; and
wherein the data processing circuitry is further configured to determine a pose of the camera within the environment from a correlation between the sequence of images and the motion data.

3. Camera system of claim 2, wherein the data processing circuitry is further configured to
determine a change of perspective of the camera by comparing a first image of the sequence of images with a second image of the sequence of images following the first image; and
determine the pose of the camera within the environment from a correlation between the motion data and the change of perspective.

4. The camera system of claim 3, wherein the data processing circuitry is further configured to
determine a first patch within the first image, wherein the first patch is indicative of a target within the environment;
determine a second patch indicative of the target within the second image by comparing the first patch with the second image; and
determine the change of perspective from a shift between the first and the second patch.

5. The camera system of claim 4, wherein the data processing circuitry is further configured to
determine a third patch indicative of the target within a third image following the second image by comparing the first patch with the third image; and
determine the change of perspective from a shift between the first and the third patch.

6. The camera system of claim 4, wherein the data processing circuitry is further configured to determine a position of the target from the correlation between the change of perspective and the motion data.

7. The camera system of claim 6, wherein the data processing circuitry is further configured to determine a velocity of the target by tracking the position of the target.

8. The camera system of claim 6, wherein the data processing circuitry is further configured to
register the position of the target in a digital map of the environment; and
determine a fourth patch indicative of the target within a fourth image based on the pose of the camera and the digital map.

9. The camera system of claim 1, wherein the motion measurement unit comprises an inertial measurement unit, IMU, which is rigidly mounted to the camera and configured to provide at least a portion of the motion data.

10. The camera system of claim 1, wherein the motion measurement unit comprises a global positioning system, GPS, sensor which is installed at the mobile device and configured to provide at least a portion of the motion data.

11. The camera system of claim 1, wherein the camera is freely mounted to the mobile device by a camera stabilizer.

12. The camera system of claim 1, wherein the camera is freely mounted to the mobile device by an elastic mounting.

13. A camera system, comprising
a first camera;
a first motion measurement unit configured to provide first motion data of the first camera;
at least one second camera;
a second motion measurement unit configured to provide second motion data of the second camera; and
a data processing circuitry configured to determine a relative pose of the first camera and the second camera towards each other from a correlation between the first motion data and the second motion data.

14. The camera system of claim 13,
wherein the first camera is configured to provide a first sequence of images of an environment;
wherein the second camera is configured to provide a second sequence of images of the environment; and
wherein the data processing circuitry is further configured to determine the relative pose of the first camera and the second camera towards each other from a correlation between the first motion data, the second motion data, the first sequence of images and the second sequence of images.

15. The camera system of claim 13, wherein at least one of the first and the second camera is freely mounted to a mobile device.

16. The camera system of claim 13, wherein the data processing circuitry is further configured to
determine a position of a target within the environment from a correlation between the first sequence of images and the first motion data;
register the position of the target in a digital map of the environment; and
detect the target within the second sequence of images using the digital map, the motion data and the relative pose of the first and the second camera.

17. The camera system of claim 13, wherein the first camera is mounted to a first mobile device and the second camera is mounted to a second mobile device.

18. A method for localizing a camera of a camera system for a mobile device, comprising:
providing motion data of the camera using at least one motion measurement unit, wherein the camera is freely mounted to the mobile device; and
determining a pose of the camera from the motion data.

19. A method for localizing multiple cameras of a camera system for a mobile device, comprising:
providing first motion data of a first camera of the camera system using a first motion measurement unit;
providing second motion data of at least one second camera of the camera system using a second motion measurement unit; and
determining a relative pose of the first camera and the second camera towards each other through a comparison of the first motion data and the second motion data.

20. A distributed camera system, comprising:
a first camera configured to provide a first sequence of images of an environment;
a first motion measurement unit configured to provide first motion data of the first camera;
a first data processing circuitry configured to
determine a position of target within the environment from a correlation between the first motion data and the first sequence of images;
register the position of the target in a digital map of the environment; and
provide the digital map of the environment.
at least one second camera configured to provide a second sequence of images of an environment;
a second motion measurement unit configured to provide second motion data of the second camera; and
a second data processing circuitry configured to
determine a relative pose of the first camera and the second camera towards each other from a correlation between the first motion data and the second motion data;
receive the digital map of the environment; and
detect the target with at least one of the images of the second sequence of images based on and the digital map and the relative pose of the first camera and the second camera towards each other.
